(19) United States
(12) Patent Application Publication
(10) Pub. No.: US 2024/0256353 A1
(43) Pub. Date: Aug. 1, 2024

(54) WORKLOAD SCHEDULING BASED ON INFRASTRUCTURE GROUPS ASSIGNED TO WORKLOADS

(71) Applicant: Hewlett Packard Enterprise Development LP, Spring, TX (US)

(72) Inventors: John Lenihan, Galway (IE); Thavamaniraja Sakthivel, Bangalore (IN); Lilun Cheng, San Jose, CA (US)

(21) Appl. No.: 18/160,695

(22) Filed: Jan. 27, 2023

(51) Int. Cl. G06F 9/50; G06F 9/48

(52) U.S. Cl. CPC G06F 9/505; G06F 9/4881

(57) ABSTRACT

Examples described herein relate to a workload scheduler for deploying a workload in a private cloud. Responsive to determining that the private cloud has insufficient resources to host a pending workload, the workload scheduler may determine whether the private cloud comprises a preemptible workload based on infrastructure group metadata tags assigned to the already-deployed workloads. Further, the workload scheduler may preempt the preemptible workload from the private cloud upon determining that the private cloud comprises the preemptible workload. Then, the workload scheduler may deploy the pending workload in the private cloud.

### BACKGROUND

Cloud computing infrastructures, such as public clouds and private clouds, have gained immense popularity, especially due to benefits such as high availability of resources, scalability, on-demand (e.g., as-a-service) offerings, and usage-derived operating costs. Typically, a public cloud employs shared and on-demand information technology (IT) resources (e.g., compute, storage, and/or networking systems) delivered by a third-party provider, typically, referred to as a public cloud service provider. On the other hand, the resources in the private clouds may be assigned for dedicated use by a single customer/organization. In both the public cloud and the private clouds, a customer may be able to deploy workloads (e.g., virtual computing systems, such as virtual machines, containers, pods, applications, etc.) and use one or more types of cloud services offered by these cloud platforms.

Services hosted on public clouds (hereinafter referred to as cloud services) are managed by a third-party provider (e.g., public cloud service provider) at a remote location, offering highly flexible and scalable cloud resources for many enterprises and organizations. Cloud services are features/capabilities of the cloud (public, private, or hybrid) offered via cloud service providers to manage customers' workloads via respective cloud management platforms over the Internet. By way of example, these cloud services may include storage, computing power, and software applications. Organizations with specific or predictable storage and processing needs commonly deploy services in public clouds, and those public cloud services are delivered by third-party providers in one of several models, including infrastructure as a service (IaaS), platform as a service (PaaS), and software as a service (Saas). In these deployments, the public cloud service provider takes responsibility for managing and updating the public cloud, rather than the end users being laden with that responsibility. For example, for an agreed-upon rate, the public cloud service provider manages and secures resources or storage for the customers.

In certain situations, due to, for example, data security concerns and the reduced overall control of data and technology of the public clouds, organizations may prefer to use private clouds to deploy workloads. A private cloud is a type of on-site cloud computing architecture that is accessed, managed, and secured by an independent enterprise or organization, providing additional virtual processing and storage resources. With a private cloud architecture, end users are not beholden to third-party providers, giving them more controlled access to their data and the ability to respond quickly in the case of component failures. Moreover, since the resources of the private cloud are located on the premises and not shared with multiple tenants, the private cloud may enable more opportunities for customized IT architectures. However, it is wasteful to overprovision in a private cloud since there are no other tenants to use the extra resources, so it usually does not make financial sense to overprovision the private cloud. Therefore, typically, the private clouds are generally provisioned with resources as per the planned usage capacity of the respective tenants.

### BRIEF DESCRIPTION OF THE DRAWINGS

Features, aspects, and advantages of the present specification will become better understood when the following detailed description is read with reference to the accompanying drawings in which like characters represent like parts throughout the drawings.

FIG. 1 depicts a system in which various of the examples presented herein may be implemented.

FIG. 2 depicts a flow diagram of an example high-level method for deploying a workload.

FIGS. 3A and 3B depict a flow diagram of another example method for deploying a workload based on a first preemption policy defined using infrastructure group priorities.

FIGS. 4A and 4B depict a flow diagram of yet another example method for deploying a workload based on a second preemption policy defined using infrastructure group priorities and additional parameters.

FIG. 5 depicts a flow diagram of an example method for preempting a workload.

FIG. 6 depicts a block diagram of an example workload scheduler.

It is emphasized that, in the drawings, various features are not drawn to scale. In fact, in the drawings, the dimensions of the various features have been arbitrarily increased or reduced for clarity of discussion.

### DETAILED DESCRIPTION

In the case of a public cloud, there typically exists a significantly large number of resources compared to a private cloud. Accordingly, there may be sufficient resources available to schedule almost any practically encountered workload deployment request in the public cloud. However, the private cloud is typically more tightly resource constrained. Furthermore, adding resources to a private cloud may not be financially viable for the enterprise, especially if the need for cloud resources is caused by additional workloads requesting cloud resources beyond a baseline level regularly used by the enterprise. Even if the enterprise is willing and able to increase cloud resources, most enterprises do not have those resources sitting idle waiting to be turned on during a surge in utilization. Accordingly, if a new workload deployment request is received and the private cloud does not have sufficient resources to host the workload specified in the new workload deployment request, the workload will often remain undeployed until sufficient resources are made available, usually due to earlier workloads completing/terminating.

Some existing solutions have addressed a related problem in the public cloud. Public clouds are often underutilized due to fluctuations in workloads across many tenants. While some of those fluctuations are attenuated by the multi-tenant architecture (i.e., one tenant uses more resources when another tenant uses fewer resources), there are still times when substantial excess capacity is available on a public cloud. The public cloud service providers monetize that excess capacity by offering unused resources (referred to as spot instances) at discounted prices with the caveat that the spot instances may be terminated when the resources allocated to them are required by other workloads from another tenant. Accordingly, such spot instances may not be for certain workloads as the customer of such spot instances may not have control over the lifespan of the spot instance. In a way, these spot instances may be best suited for flexible and non-critical workloads.

In contrast, private clouds do not encounter the issue of excess capacity in the same way. It is much more cost-effective to size a private cloud to a “baseline plus” capacity (i.e., enough resources for baseline usage plus a certain small percentage of overhead for commonly encountered levels of increased utilization) and thus minimize the excess capacity. Private clouds do, however, encounter a different issue at times. When utilization of the private cloud is high, workloads are often provided resources on a first come-first served basis. Even if attempts are made to prioritize certain workloads over others in a pending workload queue, the private cloud cannot provide resources to a new pending workload when the requisite capacity has already been allocated to already executing workloads.

To solve this issue, a workload scheduler, in examples consistent with the teachings of this disclosure, improves the management of requests to deploy pending workloads in a resource-constrained private cloud by taking into account whether there are currently executing workloads that could be preempted to free up enough resources to allow the pending workloads to be deployed. In particular, the workload scheduler may be configured to implement priority scheduling based on infrastructure group-level metadata tags (hereinafter referred to as infrastructure group (IG) metadata) assigned to each workload. An infrastructure group may be a user-defined categorization of a workload based on predefined criteria such as, for example, an intended application environment of the workload. Further, the infrastructure group metadata tag may be a label or an identifier assigned to each infrastructure group. Examples of such infrastructure group metadata tags include labels such as “production,” “test,” “development,” and the like. In this example, the infrastructure group metadata tag “production” may be assigned to workloads that are performing duties in real-time production or a live execution of customer's applications, “test” may be assigned to the workloads that are used to evaluate applications that are in the testing phase post or during development, and “development” may be assigned to the workloads that are used to develop new applications. The infrastructure group metadata tags may be assigned a priority indicative of the importance of the associated resources. For example, “production” may be designated the highest priority, “test” a medium priority, and “development” the lowest priority.

During operation, a workload deployment request to deploy a pending workload may be fetched from a pending workload queue. In an event the private cloud has insufficient resources, and the pending workload is required to be deployed, a preemptible workload may be identified based on the infrastructure group metadata tags assigned to the pending workload and the already-deployed workloads. In some examples, the preemptible workload may be identified based on priorities assigned to the infrastructure group metadata tags of the pending workload and the already-deployed workloads. In one example, the preemptible workload may be identified from the infrastructure group metadata tags that have priorities lower than the infrastructure group metadata tag of the pending workload. Once the preemptible workload is identified, the workload scheduler may preempt the preemptible workload from the private cloud so that the resources previously allocated to the preemptible workload become available to support the new deployments. After preempting the preemptible workload, the workload scheduler may deploy the pending workload in the private cloud.

As will be appreciated, the proposed workload scheduler may preempt workloads of the infrastructure group metadata tags that have a lower infrastructure group priority compared to the infrastructure group metadata tag of the pending workload. Also, in some examples, the proposed workload scheduler may allow an administrator to define certain infrastructure group metadata tags as non-preemptible, thereby excluding the respective already-deployed workloads from the consideration for preemption. As a result, if the infrastructure group metadata tags are managed rightly, the workload scheduler may not adversely impact the already-deployed workloads on the private cloud. Moreover, the proposed workload scheduler may ensure that workloads having an infrastructure group metadata tag with higher priority remain operational. As such, with the management of the infrastructure group metadata tags under an administrator's control, the preemption of the workloads by the proposed solution is much more predictable. Moreover, since the proposed solution preempts the workloads of lower-priority infrastructure group metadata tags, the administrator can efficiently utilize their available resources which reduces expansion costs.

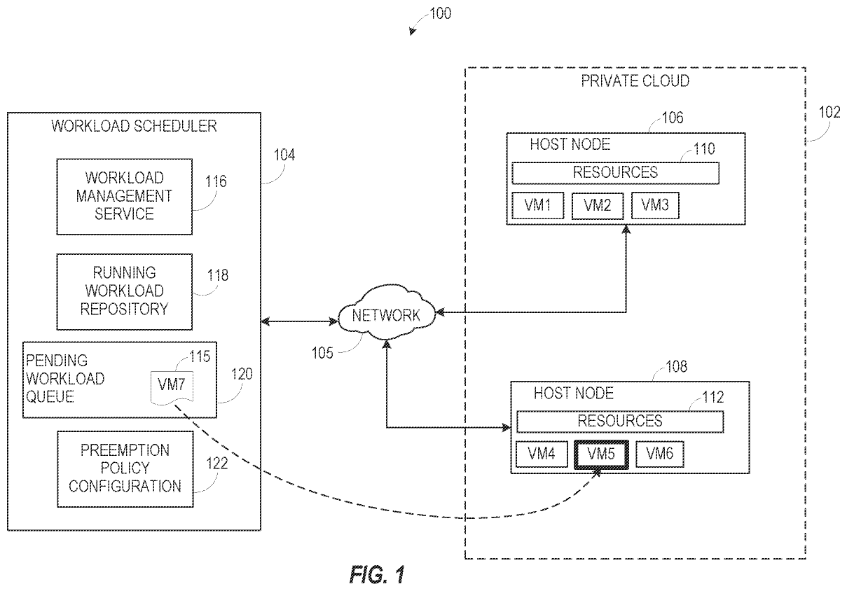

FIG. 1 illustrates an example system 100 for managing workloads in a private cloud. The system 100 is a networked system including a private cloud 102 and a workload scheduler 104. The workload scheduler 104 is connected to the private cloud 102 via a network 105. In some examples, the workload scheduler 104 may be deployed within the private cloud 102.

The system 100 may be a distributed system where the private cloud 102 and the workload scheduler 104 are located at physically separate locations (e.g., on different racks, on different enclosures, in different buildings, in different cities, in different countries, and the like) while being connected via the network 105. In certain other examples, the system 100 may be a turnkey solution or an integrated product. In some examples, the terms “turnkey solution” or “integrated product” may refer to a ready-for-use packaged solution or product where the private cloud 102, the workload scheduler 104, and the network 105 are all disposed within a common enclosure or a common rack. Moreover, in some examples, the system 100 in any form, be it the distributed system, the turnkey solution, or the integrated product, may be capable of being reconfigured by adding or removing host nodes and/or by adding or removing internal resources (e.g., compute, storage, network cards, etc.) to and from the private cloud 102 and/or the workload scheduler 104.

The private cloud 102 may be a private network of computing, storage, and/or networking systems that may implement security and access controls to restrict access to authorized users of the private cloud 102. The authorized users may have necessary permissions and/or login credentials to access services offered via the resources hosted in the private cloud 102. In some examples, the private cloud 102 may be deployed on-site that is accessed, managed, and secured by a private cloud service provider in compliance with service level agreements with the tenant of the private cloud and/or under the control of the tenant of the private cloud. The private cloud 102 may include one or more host nodes, for example, host nodes 106 and 108. In FIG. 1, although the private cloud 102 is shown to include two host nodes 106-108, the use of any number of host nodes is also envisioned, without limiting the scope of the present disclosure.

The host nodes 106-108 are communicatively coupled to the workload scheduler 104 via a network 105. Examples of the network 105 may include, but are not limited to, an Internet Protocol (IP) or a non-IP-based local area network (LAN), a wireless LAN (WLAN), a metropolitan area network (MAN), a wide area network (WAN), a storage area network (SAN), a personal area network (PAN), a cellular communication network, a Public Switched Telephone Network (PSTN), and the Internet. In some examples, the network 105 may include one or more network switches, routers, or network gateways to facilitate data communication. Communication over the network 105 may be performed in accordance with various communication protocols such as but not limited to, Transmission Control Protocol and Internet Protocol (TCP/IP), User Datagram Protocol (UDP), IEEE 802.11, and/or cellular communication protocols. The communication over the network 105 may be enabled via wired (e.g., copper, optical communication, etc.) or wireless (e.g., Wi-Fi®, cellular communication, satellite communication, Bluetooth, etc.) communication technologies. In some examples, the network 105 may be enabled via private communication links including, but not limited to, communication links established via Bluetooth, cellular communication, optical communication, radio frequency communication, wired (e.g., copper), and the like. In some examples, the private communication links may be direct communication links between the workload scheduler 104 and the host nodes 106-108.

Each of the host nodes 106-108 may be a device including a processor, microcontroller, storage devices, and/or any other electronic component, or a device or system that may facilitate various compute and/or data storage services. Examples of the host nodes 106-108 may include, but are not limited to, a desktop computer, a laptop, a smartphone, a server, a computer appliance, a workstation, a storage device, and the like. The host nodes 106-108 may have similar or varying hardware and/or software configurations. By way of example, while some host nodes may have high-performance compute capabilities, some host nodes may facilitate strong data security, some host nodes may facilitate low-latency data read and/or write operations, certain host nodes may have enhanced thermal capabilities, some host nodes may be good at handling database operations, some host nodes may be good at handling graphics processing operations, or some host nodes may be better at storing a large amount of data. In certain other examples, all of the host nodes 106-108 may have similar hardware and/or software configurations.

The host nodes 106-108 facilitate resources, for example, compute, storage, graphics, and/or networking capabilities, for one or more workloads to execute thereon. The term workload as used herein may refer to a virtual computing or storage resource that is created by virtualizing underlying physical IT resources. Examples of workloads may include virtual machines (VMs), containers, pods, databases, virtual data stores, logical disks, or combinations thereof. In an example implementation of FIG. 1, for illustration purposes, the workloads are described as being VMs, such as the VM1, VM2, VM3, VM4, VM5, and VM6 (hereinafter collectively referred to as VMs VM1-VM6). It is to be noted that the number of VMs depicted in the private cloud 102 of FIG. 1 is for illustration purposes. The number of VMs that can be hosted on any host node may depend on the number of resources in the respective host nodes.

Further, although not shown in FIG. 1, in an example implementation with workload resources being VMs, the host nodes 106-108 may host VM management services, for example, a hypervisor (e.g., Hyper-V, VMware or Citrix XenServer to set up the VM server.) that may allow the host nodes to run two or more operating systems. In case the workloads are containers or pods, the host nodes 106-108 may be configured with Kubernetes host node components to facilitate a runtime environment for the containers. Example Kubernetes host node components may include Kubelet (e.g., software agent to monitor containers), Kube-proxy (e.g., a network proxy to manage communications with containers), and a container runtime (e.g., software that is responsible for creating and running containers).

The workloads such as the VMs VM1-VM6 may be configured to execute one or more applications (e.g., a banking application, a social media application, an online marketplace application, a website, etc.). It is to be noted that the scope of the present disclosure is not construed to be limited to the type, use, functionalities, and/or features offered by the workloads and/or the applications hosted by the workloads in the private cloud 102.

For illustration purposes, in the example of FIG. 1, the host node 106 is shown to host the VMs VM1, VM2, and VM3, and the host node 108 is shown to host the VMs VM4, VM5, and VM6. Although a certain number of VMs are shown as being hosted by each of the host nodes 106-108 as depicted in FIG. 1, the host nodes 106-108 may host any number of VMs depending on respective hardware and/or software configurations. Further, the host nodes 106 and 108 are configured with resources 110, and 112, respectively. The resources 110 and 112 may include CPUs, GPUs, storage devices, and/or network ports for the functioning of the VMs VM1-VM6. For illustration, in the description hereinafter, the resources 110 and 112 are described as including CPUs and GPUs.

The workload scheduler 104 is configured to manage the already-deployed workloads (e.g., the VMs VM1-VM6) on the host nodes 106-108 and/or deployment of new workloads in situations when the private cloud is running short of resources and a new workload needs to be deployed. The workload scheduler 104 may be a device including a processor or microcontroller and/or any other electronic component, or a device or system that may facilitate various compute and/or data storage services, for example, and/or in particular, the management of the workloads on the host nodes 106-108. Examples of the workload scheduler 104 may include, but are not limited to, a desktop computer, a laptop, a smartphone, a server, a computer appliance, a workstation, a storage system, or a converged or hyperconverged system, and the like that is configured to manage the deployment and scheduling of workloads.

Further, in certain examples, the workload scheduler 104 may be implemented as a virtual machine or a containerized application executing on hardware in the system 100. In one example, the workload scheduler 104 may be implemented as a virtual machine or a containerized application on any of the host nodes 106-108 in the system 100. The workload scheduler is subscribed for use by the tenant of the private cloud 102 on a pay-per-use basis for managing workload deployments in the private cloud 102. The tenant may be able to securely access the workload scheduler via a private cloud management platform which may be facilitated and managed by the private cloud service provider.

The workload scheduler 104 hosts a workload management service 116, via hardware components or by way of executing one or more instructions via a processing resource, to facilitate deployment and management of workloads on the host nodes 106-108. In some examples, the workload management service 116 may communicate with or may be built on top of the VM management software such as VMware vSphere, Veeam ONE, Hyper-V, Red Hat Virtualization, and the like. In certain examples, the workload management service 116 may communicate with or may be built on top of container orchestrator services, for example, Kubernetes control plane services.

Further, the workload scheduler 104 maintains a running workload repository 118 storing information of already-deployed workloads (e.g., VM1-VM6) in the private cloud 102. In particular, the running workload repository 118 stores information including, but not limited to, workload identifiers, infrastructure group metadata tag (IGMT), infrastructure group priority, preemptibility instruction (PTB), power state (PS), allocated resources, resource utilization, and age (in days). Table-1 represented below shows an example content of the running workload repository 118. In Table-1, resources R1, R2, and R3 respectively represent the number of CPUs, the amount of RAM in GB, and the amount of storage in GB.

TABLE 1
Example content of the running workload repository 118

| | | IG | | | | | | | | | |
|---|---|---|---|---|---|---|---|---|---|---|---|
| | | Priority | | | Resources | | | Utilization (%) | | | Age |
| VM | IGMT | Value | PTB | PS | R1 | R2 | R3 | R1 | R2 | R3 | (Days) |
| VM1 | Production | 3 | No | ON | 4 | 8 | 40 | 40 | 40 | 35 | 30 |
| VM2 | Production | 3 | No | OFF | 16 | 32 | 80 | 80 | 30 | 20 | 120 |
| VM3 | Dev | 2 | Yes | ON | 8 | 16 | 60 | 60 | 10 | 20 | 60 |
| VM4 | Dev | 2 | Yes | OFF | 8 | 8 | 20 | 20 | 45 | 25 | 90 |
| VM5 | Test | 1 | Yes | OFF | 4 | 8 | 40 | 40 | 50 | 40 | 20 |
| VM6 | Test | 1 | Yes | OFF | 4 | 4 | 20 | 20 | 40 | 45 | 30 |

In the example data depicted in Table-1, the infrastructure group metadata tags “Production,” “Dev,” and “Test” are assigned infrastructure group priority values of 3, 2, and 1, respectively. The infrastructure group priority value indicates the importance of the infrastructure group metadata tag regarding preemption. In the example of Table-1, a greater infrastructure group priority value indicates that the respective infrastructure group metadata tag has a higher immunity (or higher infrastructure group priority) to preemption and respective workloads may be preempted after preempting the workloads belonging to a lower priority infrastructure group metadata tag. For example, the infrastructure group metadata tag—“production” with the infrastructure group priority value of 3 is a higher priority infrastructure group metadata tag compared to infrastructure group metadata tags—“Dev” and “Test” having respective infrastructure group priority values of 2 and 1. Accordingly, the workloads belonging to an infrastructure group metadata tag of the higher infrastructure group priority will be preempted at a later point in time compared to the workloads belonging to the infrastructure group metadata tag of a lower infrastructure group priority.

In some examples, the order of the infrastructure group priority values may be altered which may change the infrastructure group priority of the respective infrastructure group metadata tag. For example, the infrastructure group metadata tags “Production,” “Dev,” and “Test” are assigned infrastructure group priority values of 1, 2, and 3, respectively. In this example, a smaller infrastructure group priority value indicates that the respective infrastructure group metadata tag has a higher immunity (or higher infrastructure group priority) to preemption and respective workloads may be preempted after preempting the workloads belonging to an infrastructure group metadata tag of a higher infrastructure group priority value. In the rest of the description, the example order of infrastructure group priority values shown in Table-1 will be used for further illustration.

Certain infrastructure group metadata tags may be marked as non-preemptible. The infrastructure group metadata tag “Production” is marked as non-preemptible, and the infrastructure group metadata tags “Dev” and “Test” are marked as preemptible. Further, the columns “Resources,” “Utilization,” and “Age” provide respective information for the already deployed VMs VM1-VM6. In the description hereinafter, for illustration, the VMs VM1-VM6 are referred to as the already-deployed VMs.

In addition, the workload scheduler 104 also stores a pending workload queue 120. The pending workload queue 120 may include information such as resource requirements, an infrastructure group metadata tag, an infrastructure group priority, and the preemptibility corresponding to a pending workload. In particular, on receiving the workload deployment request 115, the workload management service 116 may update the pending workload queue 120 by creating an entry for a pending workload (e.g., VM7) requested to be deployed via the workload deployment request. Table-2 represented below shows an example content of the pending workload queue 120 based on the workload deployment request.

TABLE 2
Example content of the pending workload queue 120

| | | IG | | | | |
|---|---|---|---|---|---|---|
| | | Priority | | Resources | | |
| VM | IGMT | Value | PTB | R1 | R2 | R3 |
| VM7 | Production | 3 | No | 4 | 8 | 40 |

Furthermore, the workload scheduler 104 also stores a preemption policy configuration 122. The preemption policy configuration 122 may include threshold values of the parameters such as resource utilization, age, and power states. Also, the preemption policy configuration 122 may include one or more criteria, conditions, and/or rules for identifying preemptible workloads based on such threshold values of the parameters. A preemptible workload refers to one or more of the already-deployed workloads that can be preempted to make resources available for deploying the pending workload.

In accordance with the examples presented herein, the workload scheduler 104 aids in managing the already-deployed VMs on the host nodes 106-108 in situations when the private cloud 102 is running out of resources while deploying any pending workload (e.g., a pending VM). In particular, the workload scheduler 104 creates a space for new VM deployment in situations when there are no sufficient resources available in any single host node in the private cloud 102. To do this, the workload scheduler 104 implements a preemptive priority scheduling based on infrastructure group metadata tags assigned to workloads.

The workload scheduler 104 fetches a pending workload from a pending workload queue 120 and initiates a process of deploying the pending workload. If the private cloud 102 has insufficient resources to host the pending workload, the workload scheduler 104 determines whether the private cloud 102 comprises a preemptible workload based on the infrastructure group metadata tags assigned to the pending workload (e.g., VM7) and the already-deployed workloads (e.g., VM1-VM6). The preemptible workload is identified based on the infrastructure group priorities (see Table-1 and Table-2) of the pending workload and the already-deployed workloads. In one example, the preemptible workload may be identified from the infrastructure group metadata tags that have infrastructure group priorities lower than the infrastructure group metadata tag of the pending workload. By way of example, the workload scheduler 104 may identify VM5 as the preemptible workload as it has lower infrastructure group priority compared to the pending workload VM7 and has been allocated resources sufficient to meet the resource requirement of VM7.

In some other examples, the workload scheduler 104 may also consider additional parameters such as workload age, workload utilization, workload power status, or combinations thereof to identify the preemptible workload. In particular, the workload scheduler 104 may consider current values of one or more of the workload age, workload utilization, workload power status, and the preemption criteria specified in the preemption policy configuration 122 to identify preemptible workload(s). Once the preemptible workload is identified, the workload scheduler 104 preempts the preemptible workload (e.g., VM5) from the private cloud 102 so that the resources previously allocated to the preemptible workload become available to support the new deployments. After preempting the preemptible workload, the workload scheduler may deploy the pending workload (VM7, illustrated using a dashed arrow) in the private cloud 102.

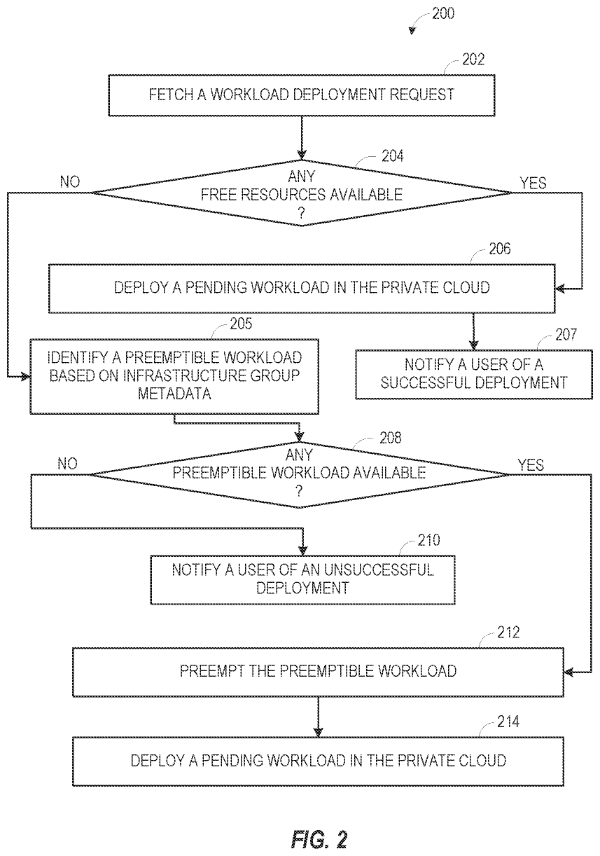

Referring now to 2, a flow diagram of an example method 200 for deploying a workload is presented. The method 200 includes several operations which may be performed by the workload scheduler 104. In certain examples, one or more of these operations may be performed by the processing resource by executing one or more of the instructions stored in the machine-readable storage medium. Certain details of the operations have already been described in conjunction with FIG. 1, which are not repeated herein for the sake of brevity. For ease of illustration, the method 200 of FIG. 2 is described in conjunction with FIG. 1. However, details and/or examples presented herein should not be construed to be limited by the specifics of FIG. 1.

At block 202, the workload scheduler 104 fetches a request to deploy a pending workload in a private cloud 102. In particular, the workload scheduler 104 may access the pending workload queue 120 and select a deployment request as per an order (e.g., first-in-first-out order) in which the deployment request is received by the workload scheduler 104.

Further, at block 204, the workload scheduler 104 performs a check to determine whether the private cloud 102 has sufficient free resources to host the pending workload. In particular, the workload scheduler 104 may identify the resource requirement of the pending workload from the pending workload queue 120 and compare it against free resources in each of the host nodes 106-108 in the private cloud 102. If the free resources in any host node are equal to or greater than the resource requirement of the pending workload, the workload scheduler 104 determines that the private cloud 102 has sufficient resources to host the pending workload. For example, for the pending workload VM7 that requires 4 CPUs, 8 GB of RAM, and 40 GB of storage space, if any of the host nodes 106 and 108 has sufficient free resources (e.g., more than or equal to 4 CPUs, 8 GB of RAM, and 40 GB of storage space), the workload scheduler 104 determines that the private cloud 102 has sufficient resources to host VM7.

At block 204, if it is determined that the private cloud 102 has sufficient resources to host the pending workload (‘YES’ at block 204), the workload scheduler 104, at block 206, deploys the pending workload in the private cloud 102. In particular, the workload scheduler 104 may deploy the pending workload on the host node that has sufficient free resources. In case more than one host node is identified to have sufficient free resources to host the pending workload, the workload scheduler 104 may select one of the host nodes using any host node selection criteria without limiting the scope of the present disclosure. After the pending workload is deployed, at block 207, the workload scheduler 104 notifies the user (who initiated the workload deployment request) or an administrator of the successful deployment of the workload by sending a notification. The notification may be sent using one or more messaging techniques, displaying an alert message on a display, via a text message such as a short message service (SMS), a Multimedia Messaging Service (MMS), and/or an email, via an audio alarm, video, or an audio-visual alarm, a phone call, etc.

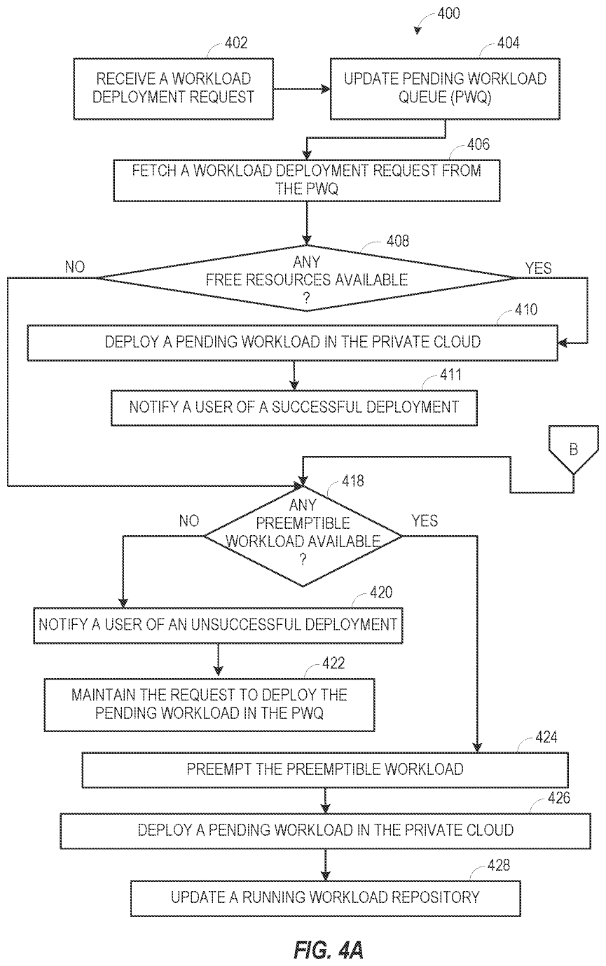

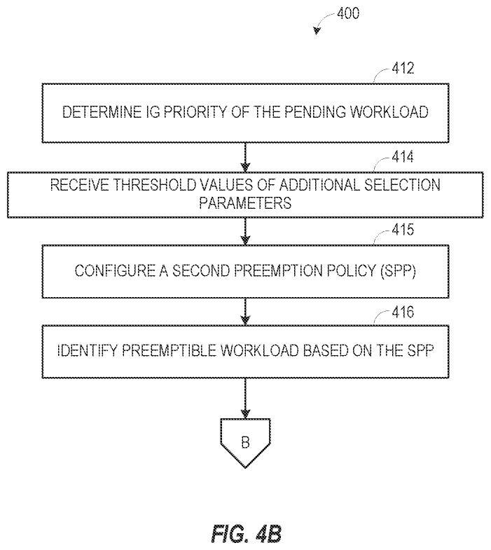

Referring again to block 204, if it is determined that the private cloud 102 has insufficient resources to host the pending workload (‘NO’ at block 204), the workload scheduler 104, at block 205, analyzes the already deployed workloads to identify any preemptible workload based on the respective infrastructure group metadata tags. The preemptible workload refers to one or more of the already-deployed workloads that can be preempted to make resources available for deploying the pending workload. The preemptible workload may be identified based on the infrastructure group priorities of the pending workload (e.g., VM7) and the already-deployed workloads (e.g., VM1-VM6). In one example, the preemptible workload may be identified from the infrastructure group metadata tags that have infrastructure group priorities lower than the infrastructure group priority of the pending workload. In some other examples, the workload scheduler 104 may also consider additional parameters such as workload age, workload utilization, workload power status, or combinations thereof to identify the preemptible workload (see FIGS. 4A-4B)

Further, at block 208, the workload scheduler 104 performs another check to determine whether the private cloud 102 has any preemptible workload based on the identification at block 205. If any preemptible workload is identified, the workload scheduler 104 may determine that the private cloud 102 has preemptible workloads. However, if no preemptible workload is identified, the workload scheduler 104 may determine that the private cloud 102 does not have any preemptible workload.

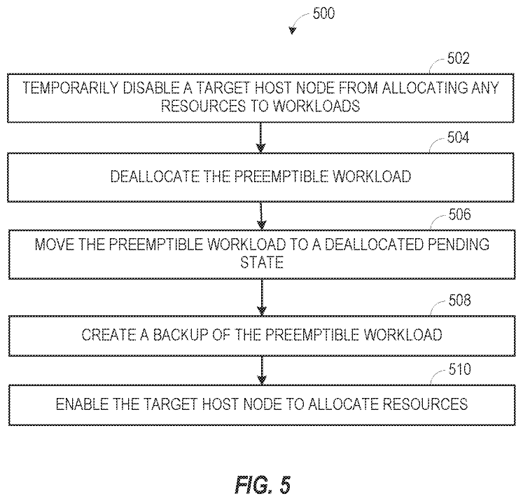

At block 208, if it is determined that the private cloud 102 does not have any preemptible workload (‘NO at block 208), the workload scheduler 104, at block 210, notifies the user (who initiated the workload deployment request) or the administrator of an unsuccessful deployment of the workload by sending a notification as described with reference to block 207, for example. However, at block 208, if it is determined that the private cloud 102 has one or more preemptible workloads (‘YES’ at block 208), the workload scheduler 104, at block 212, preempts the preemptible workload from the private cloud 102. Upon preempting the preemptible workload, a target host node (e.g., the host node that hosted the preemptible workload) may have sufficient resources to host the pending workload belonging to an infrastructure group metadata tag of a higher priority compared to that of the preemptible workload. Example steps of preempting the workload are described in conjunction with FIG. 5. After preempting the preemptible workload, the workload scheduler 104, at block 214, deploys the pending workload in the private cloud.

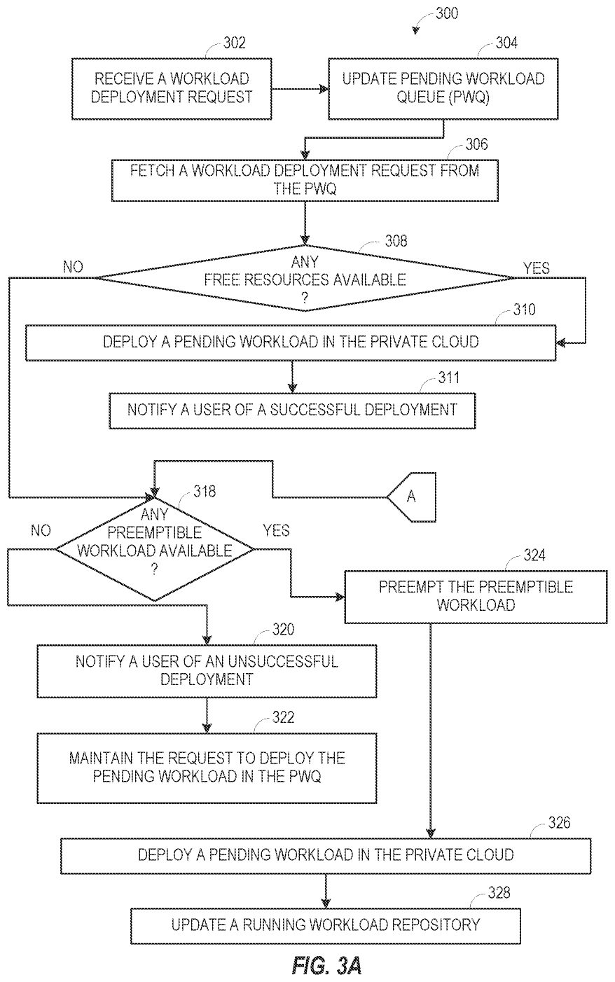

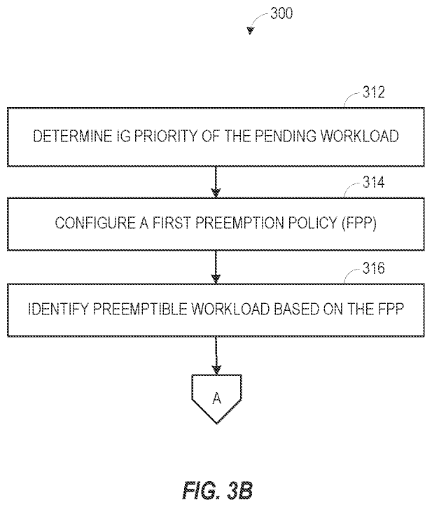

Referring now to FIGS. 3A and 3B, a flow diagram of an example method 300 for deploying a workload based on a first preemption policy defined using infrastructure group priorities is presented. The method 300 includes several operations, one or more of which may be performed by the workload scheduler 104. The method 300 is an example representative of the method 200 of FIG. 2 and may include certain additional details and/or additional blocks than described in FIG. 2. For ease of illustration, the method 300 is described in conjunction with FIG. 1. However, details and/or examples presented herein should not be construed to be limited by the specifics of FIG. 1. Moreover, certain details of the operations in method 300 have already been described in conjunction with FIGS. 1 and 2, which are not repeated herein for the sake of brevity.

At block 302, the workload scheduler 104 receives a workload deployment request. The workload deployment request may be initiated by a user via a workload deployment and management application hosted locally on the user's computer or on a cloud platform. For example, the user may log in to his/her account on the workload deployment and management service and define one or more parameters (e.g., via a graphical user interface) for a new VM to be deployed and/or may select a ready-made template (e.g., VM image) with preconfigured resource requirements for the new VM. Once the user finalizes and submits the configuration of the workload, the workload deployment request may be received by the workload scheduler 104. In particular, the workload deployment request (see syntax-1, for example) may define the resource requirements for the new container.

Syntax-1 presented below represents an example portion of a workload deployment request to deploy a new workload, for example, VM7. The workload to be deployed as per such a workload deployment request may be referred to as a pending workload (e.g., a pending VM). The workload deployment request may specify information including, but not limited to, infrastructure group metadata tag, infrastructure group priority, preemptibility, and/or resource requirements including, the number of CPUs, the amount of RAM, and the amount of storage space to be allocated to the pending workload.

Syntax 1 - Example portion of a workload deployment request

```
{
  ....
  “CPU”: “4”
  “RAM”: “8 GB”
  “Storage”: “40 GB”
  “IG”: “Production”
  “IG Priority”: “3”
  “Is Preemptible?”: “No”
  ...
  }
```

On receiving the workload deployment request, the workload scheduler 104, at block 304, updates the pending workload queue 120 by creating an entry for the pending workload requested to be deployed via the workload deployment request. Table-2 presented earlier shows an example content of the pending workload queue 120 based on the workload deployment request. Further, depending on a deployment schedule/frequency (e.g., immediate, daily, periodically at a few hours, at a particular time of the day, or on user demand), the workload scheduler 104, at block 306, fetches the workload deployment request from the pending workload queue 120. Further, the workload scheduler 104 analyzes the workload deployment request to determine the resource requirements of the pending workload.

Further, at block 308, the workload scheduler 104 performs a check to determine whether the private cloud 102 has sufficient resources to host the pending workload. At block 308, if it is determined that the private cloud 102 has sufficient resources to host the pending workload (‘YES’ at block 308), the workload scheduler 104, at block 310, deploys the pending workload in the private cloud 102. Further, after the pending workload is deployed, at block 311, the workload scheduler 104 notifies the user (who initiated the workload deployment request) or an administrator about the successful deployment of the workload by sending a notification.

Furthermore, at block 312, the workload scheduler 104 determines the infrastructure group priority (IG priority) of the pending workload based on the data retrieved from the pending workload queue 120. Then, at block 314, the workload scheduler 104 configures a first preemption policy based on the infrastructure group priority of the pending workload. In particular, configuring the first preemption policy may include setting a rule to select a matching workload as the preemptible workload. The matching workload may be selected from the already running workloads belonging to the infrastructure group metadata tags having priorities lower than the infrastructure group priority of the pending workload. The term matching workload as used herein may refer to a set of workloads on a single host node that is collectively assigned resources equal to or more than the resource requirement of the pending workload. Thereafter, the workload scheduler 104 may use the first preemption policy to identify preemptible workloads at block 316. Identifying the preemptible workloads based on the first preemption policy may include selecting the matching workload that has an infrastructure group priority lower than the infrastructure group priority of the pending workload. In some examples, operations at blocks 312-316 may be performed after the workload scheduler 104 has fetched the workload deployment request at block 306.

Referring again to block 308, if it is determined that the private cloud 102 has insufficient resources to host the pending workload (‘NO’ at block 308), the workload scheduler 104, at block 318, performs another check to determine whether the private cloud 102 has any preemptible workload. The workload scheduler 104 implements the priority-based preemption policy to identify the preemptible workloads. By way of example, for the pending workload—VM7, as per an example priority-based preemption policy, the workload scheduler 104 may select one or more matching workloads from the already-running workloads belonging to infrastructure group metadata tags having infrastructure group priorities 1 and 2. In particular, based on the resource requirement of VM7, any of the VMs VM3, VM4, and VM5 may be selected as the preemptible workload as per the priority-based preemption policy.

At block 318, if no preemptible workload is identified (‘NO’ at block 318), the workload scheduler 104, at block 320, notifies the user (who initiated the workload deployment request) or the administrator of an unsuccessful deployment of the workload by similarly sending a notification as described with reference to block 207, for example. Further, at block 322, the workload scheduler 104 maintains the request to deploy the pending workload in the pending workload queue 120. However, at block 318, if it is determined that the private cloud 102 includes any preemptible workload (‘YES’ at block 318), the workload scheduler 104, at block 324, preempts the preemptible workload from the private cloud 102. Example steps of preempting the workload are described in conjunction with FIG. 5.

After preempting the preemptible workload, the workload scheduler 104, at block 326, deploys the pending workload in the private cloud 102. Moreover, at block 328, the workload scheduler 104 updates the running workload repository 118 to store a new entry indicating the pending workload as an already-deployed workload after the pending workload is deployed in the private cloud. In particular, after deploying the pending workload VM7, the workload scheduler 104 may include the details of the pending workload VM7 (now a running workload) in the running workload repository 118. Further, the workload scheduler 104 may update the running workload repository 118 by removing the entry corresponding to the workload that was preempted. Table-3 represented below depicts an updated content of the running workload repository 118 after preempting VM 5 and deploying VM7.

TABLE 3
Example content of the running workload repository 118

| | | IG | | | | | | | | | |
|---|---|---|---|---|---|---|---|---|---|---|---|
| | | Priority | | | Resources | | | Utilization (%) | | | Age |
| VM | IG | Value | PTB | PS | R1 | R2 | R3 | R1 | R2 | R3 | (Days) |
| VM1 | Production | 3 | No | ON | 4 | 8 | 40 | 40 | 35 | 20 | 30 |
| VM2 | Production | 3 | No | OFF | 16 | 32 | 80 | 30 | 20 | 50 | 120 |
| VM7 | Production | 3 | No | ON | 4 | 8 | 40 | 40 | 60 | 40 | 0 |
| VM3 | Dev | 2 | Yes | ON | 8 | 16 | 60 | 10 | 20 | 20 | 60 |
| VM4 | Dev | 2 | Yes | OFF | 8 | 8 | 20 | 45 | 25 | 30 | 90 |
| VM6 | Test | 1 | Yes | OFF | 4 | 4 | 20 | 40 | 45 | 60 | 30 |

Referring now to FIGS. 4A and 4B, a flow diagram of another example method 400 for deploying a workload based on a second preemption policy defined using infrastructure group priorities and additional parameters is presented. The method 400 includes several operations, one or more of which may be performed by the workload scheduler 104. The method 400 is an example representative of the method 300 and may include certain additional details and/or additional blocks than described in FIG. 3A-3B. For ease of illustration, the method 400 is described in conjunction with FIG. 1. However, details and/or examples presented herein should not be construed to be limited by the specifics of FIG. 1. Moreover, certain details of the operations that are already been described in conjunction with FIGS. 1, 2, and 3A-3B are not repeated herein for the sake of brevity.

At block 402, the workload scheduler 104 receives a workload deployment request, for example, to deploy a workload VM7. On receiving the workload deployment request, the workload scheduler 104, at block 404, updates the pending workload queue 120 by creating an entry for the workload. Further, depending on a deployment schedule/frequency (e.g., immediate, daily, periodically at a few hours, at a particular time of the day, or on user demand), the workload scheduler 104, at block 406, fetches the workload deployment request from the pending workload queue 120.

Further, at block 408, the workload scheduler 104 performs a check to determine whether the private cloud 102 has sufficient resources to host the pending workload. At block 408, if it is determined that the private cloud 102 has sufficient resources to host the pending workload (‘YES’ at block 408), the workload scheduler 104, at block 410, deploys the pending workload in the private cloud 102. Further, after the pending workload is deployed, at block 411, the workload scheduler 104 notifies the user (who initiated the workload deployment request) or an administrator about the successful deployment of the workload by sending a notification.

Furthermore, at block 412, the workload scheduler 104 determines the infrastructure group priority of the pending workload based on the data retrieved from the pending workload queue 120. Moreover, at block 414, the workload scheduler 104 receives threshold values corresponding to additional selection parameters such as workload age, workload utilization, workload power status, or combinations thereof. For example, the workload scheduler 104 may receive one or more of a threshold workload age, a threshold workload utilization, or a power status choice. The threshold workload age may represent a workload age in days that sets a minimum age for selecting a preemptible workload. The threshold workload utilization may be a percentage utilization of the workload below which the already-running workload may have a chance to qualify as a preemptible workload. The threshold workload utilization may be compared against an overall utilization of an already-running workload. The overall utilization for an already-running workload may be a function of the utilization of one or more of the resources (e.g., CPU, RAM, and storage) allocated to the already-running workload. In one example, in a simple form, the overall utilization may be determined as an average of the resource utilizations (e.g., an average of utilizations of R1, R2, and R3). The power status choice may be any of “running” (or ON state) or “inactive” (or OFF state). Most possibly, the power status choice may be set to inactive (or OFF state). Accordingly, the already running workloads that are in the OFF state may have a chance to qualify as preemptible workloads.

Once the threshold values are received, workload scheduler 104, at block 415, configures a second preemption policy based on the infrastructure group priority of the pending workload and one or more additional parameters and respective threshold values (received at block 414). In particular, configuring the second preemption policy may include setting a rule to select a matching workload as the preemptible workload. As per the second preemption policy, the matching workload may be selected from the already running workloads belonging to the infrastructure group metadata tags having priorities lower than the infrastructure group priority of the pending workload and that satisfies the additional conditions based on the threshold values received at block 414.

The second preemption policy may be defined based on infrastructure group priority, power state, and workload age. The user may define a workload age threshold as 30 days and the power status choice may be set to OFF state, for example. Accordingly, the second preemption policy may configure a rule to select a given matching workload as a preemptible workload if the matching workload belongs to the infrastructure group metadata tag of a lower priority compared to the pending workload, has a workload age of more than 30 days, and is in the OFF state. For an ongoing example of VM7 as the pending workload, the second preemption policy based on the infrastructure group priority, power state, and workload age, may result in VM3 and VM4 being identified as the preemptible workloads.

In another example, a second preemption policy may be defined based on infrastructure group priority, power state, and the overall utilization of already running workloads. The user may define a utilization threshold of 20% and the power status choice may be set to OFF state, for example. Accordingly, the second preemption policy may configure a rule to select a given matching workload as a preemptible workload if the matching workload belongs to the infrastructure group metadata tag of a lower priority compared to the pending workload, has an overall utilization of less than 20%, and is in the OFF state.

In yet another example, a second preemption policy may be defined based on infrastructure group priority, power state, workload age, and the overall utilization of already running workloads. The user may define a workload age threshold of 30 days, a utilization threshold of 20%, and set the power status choice to OFF state, for example. Accordingly, the second preemption policy may configure a rule to select a given matching workload as a preemptible workload if the matching workload belongs to the infrastructure group metadata tag of a lower priority compared to the pending workload, has a workload age of more than 30 days, has the overall utilization less than 20%, and is in the OFF state.

Once the second preemption policy is configured, the workload scheduler 104 may use the second preemption policy to identify preemptible workloads at block 416. In particular, at block 416, the workload scheduler 104 may select any matching workload that satisfies the second preemption policy as described hereinabove. In some examples, operations at blocks 412-416 may be performed after the workload scheduler 104 has fetched the workload deployment request at block 406.

Referring again to block 408, if it is determined that the private cloud 102 has insufficient resources to host the pending workload (‘NO’ at block 408), the workload scheduler 104, at block 418, performs another check to determine whether the private cloud 102 has any preemptible workload based on the respective infrastructure group metadata tags. In particular, the workload scheduler 104 may determine if any preemptible workload has been identified at block 416. If no preemptible workload is identified, the workload scheduler 104, at block 420, notifies the user (who initiated the workload deployment request) or the administrator of an unsuccessful deployment of the workload by sending a notification. Further, at block 422, the workload scheduler 104 maintains the request to deploy the pending workload in the pending workload queue 120.

However, at block 418, if it is determined that the private cloud 102 includes a preemptible workload, the workload scheduler 104, at block 424, preempts the preemptible workload from the private cloud 102. Example steps of preempting the workload are described in conjunction with FIG. 5. After preempting the preemptible workload, the workload scheduler 104, at block 426, deploys the pending workload in the private cloud 102. Moreover, at block 428, the workload scheduler 104 updates the running workload repository 118 to store a new entry indicating the pending workload as an already-deployed workload after the pending workload is deployed in the private cloud 102.

FIG. 5 depicts a flow diagram of an example method 500 for preempting a workload. The method 500 may represent sub-steps of the block 212 of FIG. 2, block 324 shown in FIG. 3B, and block 424 shown in FIG. 4B. For ease of illustration, the method 500 is described in conjunction with FIG. 1. However, details and/or examples presented herein should not be construed to be limited by the specifics of FIG. 1.

At block 502, the workload scheduler 104 temporarily disables a target host node from allocating any resources. The target host node may be a host node on which the preemptible workload is executing. In particular, at block 502, the workload scheduler 104 may assign a taint status to the target host node. A host node with a taint status is disabled from accepting any new container deployment request. Further, after the target host node is temporarily disabled from allocating resources, the workload scheduler 104, at block 504, deallocates the preemptible workload by withdrawing resources allocated to the set of preemptible containers. Accordingly, the target host node at the end of the operation at block 504 will have additional free resources (equivalent to the resources allocated to the preemptible workloads). In particular, upon withdrawing the resources allocated to the preemptible containers, the target host node may have sufficient resources to host the new container. Furthermore, at block 506, the workload scheduler 104 may move the set of preemptible containers to a deallocated pending state. Accordingly, the set of preemptible containers may join the wait queue in the pending workload queue 120 of the workload scheduler 104.

Furthermore, at block 508, the workload scheduler 104 creates a backup of the preemptible workload on a backup repository. The backup repository may be hosted on the workload scheduler 104, on any of the host nodes 106-108 in the private cloud 102, or on a storage system outside the private cloud 102. Moreover, at block 510, the workload scheduler 104 enables the target host node to allocate resources after the preemptible workload is moved to the deallocated pending state.

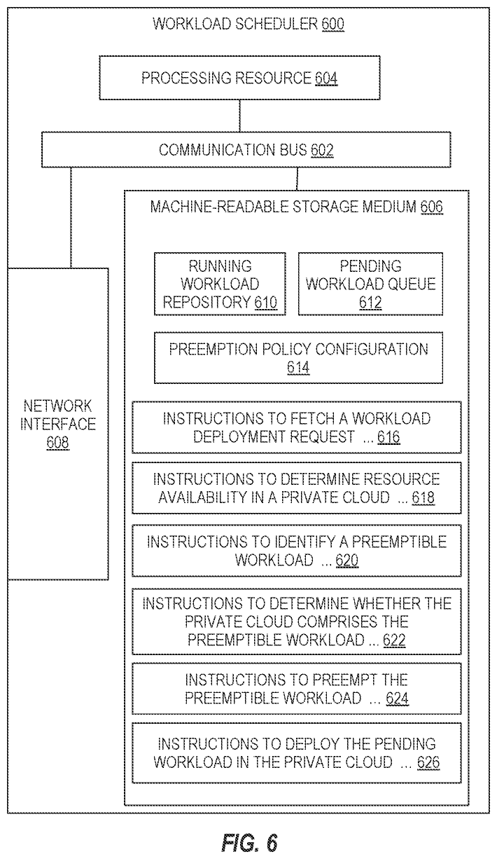

FIG. 6 depicts a block diagram of a workload scheduler 600 in which various of the examples described herein may be implemented. The workload scheduler 600 may be configured to operate as the workload scheduler 104 when deployed in the system 100 of FIG. 1 and can perform various operations described in one or more of the earlier drawings.

The workload scheduler 600 includes a communication bus 602 or other communication mechanisms for communicating information (e.g., commands and/or data), a hardware processor, also referred to as processing resource 604, and a machine-readable storage medium 606 coupled to the communication bus 602 for processing information. The machine-readable storage medium 606 may be non-transitory and is alternatively referred to as a non-transitory machine-readable storage medium 606. The machine-readable storage medium 606 may be any electronic, magnetic, optical, or any other storage device that may store data and/or executable instructions. Examples of the machine-readable storage medium 606 may include Random Access Memory (RAM), non-volatile RAM (NVRAM), an Electrically Erasable Programmable Read-Only Memory (EEPROM), a storage drive, a solid-state drive, a hard-disk drive (e.g., magnetic disk), a flash memory device, a compact disc read-only memory (CD-ROM), and the like.

The machine-readable storage medium 606 may store data and/or instructions. For example, the machine-readable storage medium 606 may store a running workload repository 610 (similar to the running workload repository 118), a pending workload queue 612 (similar to the pending workload queue 120), and a preemption policy configuration 614 (similar to the preemption policy configuration 122). The instructions encoded in the machine-readable storage medium 606 include instructions 616, 618, 620, 622, 624, and 626 (hereinafter collectively referred to as instructions 616-626) for performing one or more of the operations described in the method 200 of FIG. 2, for example. Although not shown, in some examples, the machine-readable storage medium 606 may be encoded with certain additional executable instructions to perform one or more other operations (e.g., operations described in FIGS. 2-5) performed by the workload scheduler 104, without limiting the scope of the present disclosure.

The processing resource 604 may include one or more central processing units (CPUs), semiconductor-based microprocessors, and/or other hardware devices suitable for retrieval and execution of instructions 616-626 stored in a machine-readable storage medium 606. The processing resource 604 may fetch, decode, and execute instructions 616-626, to manage the deployment of workloads when resources in the private cloud (e.g., the private cloud 102) are constrained. As an alternative or in addition to retrieving and executing instructions 616-626, the processing resource 604 may include one or more electronic circuits that include electronic components, such as a field-programmable gate array (FPGA), an application-specific integrated circuit (ASIC), or other electronic circuits for performing the functionality of one or more instructions 616-626. In some examples, when the workload scheduler 600 is implemented as a virtual resource (e.g., a VM, a container, or a software application), the processing resource 604 and the machine-readable storage medium 606 may respectively represent a processing resource and a machine-readable storage medium of a host system hosting the workload scheduler 600 as the virtual resource.

Further, the workload scheduler 600 also includes a network interface 628 coupled to the communication bus 602. The network interface 628 provides a two-way data communication coupling to one or more network links that are connected to one or more networks (e.g., the network 105). For example, the network interface 628 may be an integrated services digital network (ISDN) card, cable modem, satellite modem, or a modem to provide a data communication connection to a corresponding type of telephone line. As another example, the network interface 628 may be a local area network (LAN) card or a wireless communication unit (e.g., Wi-Fi chip/module).

The instructions 616-626 when executed by the processing resource 604 may cause the processing resource 604 to manage the already-deployed workloads in the private cloud to make a space for new workload deployments. For example, the instructions 616, when executed by the processing resource 604, may cause the processing resource 604 to fetch, from the pending workload queue 612, a request to deploy a pending workload in a private cloud. Further, the instructions 618, when executed by the processing resource 604, may cause the processing resource 604 to determine that the private cloud has insufficient available resources to host the pending workload by comparing a resource request of the pending workload to available resources of the private cloud. Furthermore, the instructions 620, when executed by the processing resource 604, may cause the processing resource 604 to identify a preemptible workload hosted by the private cloud based on infrastructure group metadata tags associated with already deployed workloads on the private cloud. Moreover, the instructions 622, when executed by the processing resource 604, may cause the processing resource 604 to determine, based on resources used by the preemptible workload, whether the private cloud has sufficient available resources to host the pending workload when including the resources used by the preemptible workload. Furthermore, the instructions 624, when executed by the processing resource 604, may cause the processing resource 604 to preempt the preemptible workload from the private cloud responsive to determining that the private cloud comprises the preemptible workload. Moreover, the instructions 626, when executed by the processing resource 604, may cause the processing resource 604 to deploy the pending workload in the private cloud after preempting the preemptible workload.

The foregoing detailed description refers to the accompanying drawings. It is to be expressly understood that the drawings are for illustration and description only. While several examples are described in this document, modifications, adaptations, and other implementations are possible. Accordingly, the following detailed description does not limit disclosed examples. Instead, the proper scope of the disclosed examples may be defined by the appended claims.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled,” as used herein, is defined as connected, whether directly without any intervening elements or indirectly with at least one intervening element, unless indicated otherwise. For example, two elements can be coupled mechanically, electrically, or communicatively linked through a communication channel, pathway, network, or system. Further, the term “and/or” as used herein refers to and encompasses any and all possible combinations of the associated listed items. It will also be understood that, although the terms first, second, third, etc., may be used herein to describe various elements, these elements should not be limited by these terms, as these terms are only used to distinguish one element from another unless stated otherwise or the context indicates otherwise. The term “based on” means based at least in part on.

While certain implementations have been shown and described above, various changes in form and details may be made. For example, some features and/or functions that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described.

In the foregoing description, numerous details are set forth to provide an understanding of the subject matter disclosed herein. However, an implementation may be practiced without some or all of these details. Other implementations may include modifications, combinations, and variations from the details discussed above. It is intended that the following claims cover such modifications and variations.

What is claimed is:

1. A method, comprising:
fetching, by a workload scheduler of a private cloud, a request to deploy a pending workload in the private cloud from a pending workload queue of the private cloud;
determining that the private cloud has insufficient available resources to host the pending workload by comparing a resource request of the pending workload to available resources of the private cloud;
identifying a preemptible workload hosted by the private cloud based on infrastructure group metadata tags associated with already deployed workloads on the private cloud;
determining, based on resources used by the preemptible workload, that the private cloud has sufficient available resources to host the pending workload when including the resources used by the preemptible workload;
preempting the preemptible workload on the private cloud; and
deploying the pending workload on the private cloud.

2. The method of claim 1, further comprising:
configuring, by the workload scheduler, a first preemption policy based on an infrastructure group priority of the pending workload; and
identifying the preemptible workload based on the first preemption policy.

3. The method of claim 1, further comprising:
receiving, by the workload scheduler, one or more of a threshold workload age, a threshold workload utilization, or a power status choice;
configuring, by the workload scheduler, a second preemption policy based on an infrastructure group priority of the pending workload and one or more of the threshold workload age, the threshold workload utilization, or the power status choice; and
identifying the preemptible workload based on the second preemption policy.

4. The method of claim 1, wherein the preempting comprises temporarily disabling a host node executing the preemptible workload from allocating resources to new workload deployments.

5. The method of claim 4, wherein the preempting comprises withdrawing resources allocated to the preemptible workload to make the resources available for allocation to the pending workload.

6. The method of claim 5, wherein the preempting further comprises enabling the host node to allocate the resources to the pending workload after the resources are withdrawn from the preemptible workload.

7. The method of claim 6, wherein the preempting further comprises creating, by the workload scheduler, a backup of the preemptible workload on a backup repository.

8. The method of claim 1, further comprising:
receiving, by the workload scheduler, the request for workload deployment; and
updating, by the workload scheduler, the pending workload queue with the request.

9. The method of claim 1, further comprising maintaining, by the workload scheduler, the request to deploy the pending workload in the pending workload queue responsive to determining that the private cloud does not comprise the preemptible workload.

10. The method of claim 1, further comprising updating, by the workload scheduler, a running workload repository to store a new entry indicating the pending workload as an already-deployed workload after the pending workload is deployed in the private cloud.

11. The method of claim 1, wherein the workload scheduler is accessible to a tenant of the private cloud via a private cloud management platform.

12. A workload scheduler, comprising:
a machine-readable storage medium storing executable instructions and a pending workload queue comprising a request to deploy a pending workload in a private cloud; and
a processing resource coupled to the machine-readable storage medium and configured to execute one or more of the instructions to:
fetch a request to deploy a pending workload private cloud from the pending workload queue of the private cloud;
determine that the private cloud has insufficient available resources to host the pending workload by comparing a resource request of the pending workload to available resources of the private cloud;
identify a preemptible workload hosted by the private cloud based on infrastructure group metadata tags associated with already deployed workloads on the private cloud;
determine, based on resources used by the preemptible workload, that the private cloud has sufficient available resources to host the pending workload when including the resources used by the preemptible workload;
preempt the preemptible workload on the private cloud; and
deploy the pending workload on the private cloud.

13. The workload scheduler of claim 12, wherein the processing resource is configured to execute one or more of the instructions to identify preemptible workload based on a first preemption policy and infrastructure group priorities defined for an infrastructure group metadata tag assigned to the pending workload and the infrastructure group metadata tags assigned to already-deployed workloads, wherein the first preemption policy defines workload selection criteria based on the infrastructure group priorities.

14. The workload scheduler of claim 13, wherein the pending workload and the already-deployed workloads on the private cloud comprise one or more of virtual machines, containers, executable applications, pods, or combinations thereof.

15. The workload scheduler of claim 13, wherein the processing resource is configured to execute one or more of the instructions to configure the first preemption policy based on a priority criterion corresponding to the infrastructure group priorities, wherein the priority criterion comprises one or more priority thresholds and a condition to select the already-deployed workloads based on the one or more priority thresholds.

16. The workload scheduler of claim 12, wherein the processing resource is configured to execute one or more of the instructions to:
receive one or more of a threshold workload age, a threshold workload utilization, or a power status choice;
configure a second preemption policy based on an infrastructure group priority of the pending workload and one or more of the threshold workload age, the threshold workload utilization, or the power status choice; and
identify the preemptible workload based on the second preemption policy.

17. The workload scheduler of claim 12, wherein the workload scheduler is subscribed for use by a tenant of the private cloud on a pay-per-use basis.

18. A non-transitory machine-readable medium storing instructions executable by a processing resource, the instructions comprising:
instructions to fetch, by a workload scheduler of a private cloud, a request to deploy a pending workload in the private cloud from a pending workload queue of the private cloud;
instructions to determine that the private cloud has insufficient available resources to host the pending workload by comparing a resource request of the pending workload to available resources of the private cloud;
instructions to identify a preemptible workload hosted by the private cloud based on infrastructure group metadata tags associated with already deployed workloads on the private cloud;
instructions to determine, based on resources used by the preemptible workload, that the private cloud has sufficient available resources to host the pending workload when including the resources used by the preemptible workload;
instructions to preempt the preemptible workload on the private cloud; and
instructions to deploy the pending workload on the private cloud.

19. The non-transitory machine-readable medium of claim 18, wherein further comprises instructions to identify preemptible workload based on a first preemption policy and infrastructure group priorities defined for an infrastructure group metadata tag assigned to the pending workload and the infrastructure group metadata tags assigned to already-deployed workloads on the private cloud, wherein the first preemption policy defines workload selection criteria based on the infrastructure group priorities.

20. The non-transitory machine-readable medium of claim 19, wherein further comprises instructions to:
receive one or more of a threshold workload age, a threshold workload utilization, or a power status choice;
configure a second preemption policy based on an infrastructure group priority of the pending workload and one or more of the threshold workload age, the threshold workload utilization, or the power status choice; and
identify the preemptible workload based on the second preemption policy.
